(19) United States
(12) Patent Application Publication
(10) Pub. No.: US 2020/0191995 A1
(43) Pub. Date: Jun. 18, 2020

(54) Method for Exploiting a Hydrocarbon Deposit Using Basin Simulation and Compositional Kinetic Modelling

(71) Applicant: IFP Energies nouvelles, Rueil-Malmaison Cedex (FR)

(72) Inventors: Matthieu DUBILLE, Viroflay (FR); Maria-Fernanda ROMERO-SARMIENTO, Rueil-Malmaison Cedex (FR); Nicolas MAURAND MANDEIX, Rueil-Malmaison Cedex (FR); Renaud TRABY, Rueil-Malmaison Cedex (FR)

(21) Appl. No.: 16/709,518

(22) Filed: Dec. 10, 2019

(30) Foreign Application Priority Data
Dec. 15, 2018 (FR) 18/72.998

(51) Int. Cl. G01V 99/00; G06F 30/20

(52) U.S. Cl. CPC G01V 99/005; G06F 2111/10; G06F 30/20

(57) ABSTRACT

The present invention is a method for determining at least one of the quantity and the quality of the hydrocarbons present in a sedimentary basin, by use of a numerical basin simulator containing a kinetic model. The kinetic model is applied with kinetic parameters in order to reproduce the transformation of the organic matter into at least one chemical compound under the effect of an increase in temperature. The present invention converts kinetic parameters relating to a first compositional representation into kinetic parameters relating to a second compositional representation, by use of a compositional reference established from reference source rocks and from the level of transformation of a reference rock.

### CROSS REFERENCE TO RELATED APPLICATIONS

Reference is made French Application No. 18/72.998 filed Dec. 15, 2018, which is incorporated herein by reference in its entirety.

### BACKGROUND OF THE INVENTION

### Field of the Invention

The present invention relates to exploration for and exploiting of at least one of oil and gas deposits.

Description of the Prior Art

Oil and/or gas exploration searches for hydrocarbon deposits within a sedimentary basin. The understanding of the principles of hydrocarbon formation and the relationships between hydrocarbons and the geological history of the ground has made it possible development of methods for evaluating at least one of the oil and gas potential of a sedimentary basin. The general approach to evaluating the at least one of oil and gas potential of the sedimentary basin involves iterations between:
predicting at least one of the oil and gas potential of the sedimentary basin, which is performed based on available information regarding the basin under study (outcrops, seismic investigations, drillings, for example).
exploration wells drilled into the various zones having the best potential, in order to confirm or disprove the potential estimated beforehand, and to acquire new data to feed to new, more precise studies.

Exploiting the at least one of oil and gas of a deposit based on the information gathered in the oil and gas exploration phases selecting the zones of the deposit presenting the best of at least one of oil and gas potential, in defining optimal exploitation diagrams for these zones (for example using reservoir simulation, to define the number and positions of exploitation wells allowing optimal hydrocarbon recovery, as well as the type of recovery), in drilling exploitation wells and, generally, in putting in place the production infrastructure required for the development of the deposit.

In certain sedimentary basins which have had a complicated geological history, involving numerous physical processes, or when the volume of data is very high, evaluating the at least one of oil and gas potential of the sedimentary basin requires the use of computational tools for the synthesis of the available data, and computational tools for simulating the geological history and the multiple physical processes that govern it. This then is an approach known as “basin modelling”. The family of so-called basin-modelling software tools allow the sedimentary, tectonic, thermal, hydrodynamic and organic and inorganic chemical processes that are involved in the formation of at least one of an oil and gas bearing basin to be simulated in one, two or three dimensions. Basin modelling conventionally comprises three steps:
a step of constructing a meshed representation of the basin under study, known as geomodelling. This meshed representation is most frequently structured in layers, that is a group of meshes is assigned to each geological layer of the modelled basin. Each mesh of this meshed representation is then filled with at least one petrophysical properties, such as the porosity, the facies (clay, sand, etc.) or else their organic-matter content at the moment of sedimentation. The construction of this model is based on data acquired via seismic campaigns or well measurements, taking of core samples, etc.
a step of structurally reconstructing this meshed representation based on representing earlier states of the architecture of the basin. This step can be performed using a method known as “backstripping” (Steckler et al., 1978) or else by a method known as structural restoration (EP 2110686).
a step of numerically simulating a selection of physical effects that occur during the evolution of the basin and that contribute to the formation of oil and gas traps. This step, known by the term “basin simulation” relies on a discretized representation of space and time. In particular, a basin simulation provides a predictive map of the subsoil, indicating the probable location of the deposits, as well as the content, nature and pressure of the hydrocarbons trapped therein. Basin simulation tools that allow the formation of a sedimentary basin to be simulated numerically are known. By way of example of the tool described in patent EP2110686 corresponding to U.S. Pat. No. 8,150,669 or in patent applications EP2816377 corresponding to US published patent application 2014/0377872, EP3075947 corresponding to US published patent application 2016/0290107, EP3182176 corresponding to US published patent application 2017/0177764. These tools estimate the evolution in temperature throughout a sedimentary basin, as well as the progress in the reaction that converts organic matter into hydrocarbons, at a volumetric analysis and at a composition of the fluids generated over the course of time.

Most known oil and gas reserves correspond to fluids of organic origin. The organic matter varies widely in terms of in elementary composition and its potential for generating hydrocarbons. These variations can be explained, on the one hand, by the very origin of the organic matter which may come from marine microorganisms, from lacustrine algae or from higher plants for example and, on the other hand, by the state of preservation of the organic matter which may notably be oxidized or degraded by microorganisms.

The main steps in the evolution of the organic matter are very strongly connected to the increase in temperature in the subsoil as they gradually become buried. During the catagenesis step, the kerogen is found to convert chiefly into hydrocarbons, amongst others. This transformation of the organic matter is dependent on time and on temperature.

In order to study petroleum systems in greater detail and better protect the quantities and quality of the hydrocarbons produced by the source rock in the sedimentary basins, geologists specializing in sedimentary basins have, for several decades now, been using quantitative and qualitative models of the transformation of the organic matter.

Indeed it is widely acknowledged that the mechanisms of the thermal cracking of the organic matter can be reproduced satisfactorily using kinetic models. These kinetic models may or may not be compositional. In the case of non-compositional kinetic models (these are also referred to as “bulk” kinetic models), it is assumed that a chemical reaction has just one product of reaction (for example that the kerogen will be converted into a fluid) and only the primary cracking of the organic matter is simulated. In the case of compositional kinetic models, these models reproduce reactions for which the cracking reaction yields several products (for example, the kerogen is converted into gas, oil and coke) and the primary cracking of the organic matter, as well as the secondary cracking of the generated products, are simulated.

### PRIOR ART

R. Braun, A. Burnham, J. G. Reynolds and J.E. Clarkson, Pyrolysis Kinetics for Lacustrine and Marine Source Rocks by Programmed Micropyrolisis—Energy Fuels, 1991, 5 (1), pp 192-204

Pepper and Corvi (1995). Simple Kinetic Models of Petroleum Formation. Part 1: Oil and Gas Generation from Kerogen

The kinetic models are calibrated on the basis of experiments conducted in a laboratory on samples of kerogen derived from a source rock. More specifically, these experiments aim to determine the kinetic parameters of a kinetic model. Using the kinetic model incorporating these kinetic parameters, it is then possible to estimate how the transformation of organic matter progresses and therefore the quantity of hydrocarbons produced over the course of time.

In order to determine these kinetic parameters, it is necessary beforehand to sample zones representative of the source rock having not yet begun the process of thermal transformation. A distinction is made between two types of analysis, aimed at determining the kinetic parameters relating to:
non-compositional kinetics: This case is a laboratory analysis routinely used in the petroleum industry. It usually is an open-system pyrolysis, conducted at temperatures comprised between around 200 and 700° C. Such an analysis may be carried out for example using the ROCK-EVAL® device (IFP Energies nouvelles, France). During the course of such an analysis, the artificial maturation of a kerogen and derived from an immature source rock is reproduced for various rates of heating (2, 5, 10, 15 and 25° C./min). These experiments make it possible to acquire data that will allow all the parallel reactions of the transformation of the organic matter to be characterized, thus making it possible to estimate the kinetic parameters of the Arrhenius equation (frequency factor Ai, activation energy Ei, and contributions relating to each of the individual reactions, parallel to the total reaction Xi; see below).
compositional kinetics: In this case the analyses required are far lengthier and more onerous than for non-compositional kinetics. The effect of this is that it is used more sporadically by the oil companies. The analyses conventionally begin with a preparatory pyrolysis yielding a non-compositional open-system overall kinetic evaluation of the isolated kerogen sample as described above. This information is then supplemented by series of closed-system heating operations (for example inside gold tubes) with different times and temperatures in duplicate (for example a first tube for gas analyses and a second tube for analysing the liquids and residues). This set of procedures for characterizing the fluids, which is experimentally more complex, requires a high number of analyses and information-processing operations. These analyses are performed by closed-system pyrolysis of an isolated sample of kerogen to predict the composition of the fluids generated in the oil window (between 250 and 375° C. for the laboratory) and/or gas window (between 400 and 550° C. for the laboratory), by integrating the primary cracking of the initial organic matter and the secondary cracking of the compounds generated. These experiments make it possible to quantify the liquid, gaseous and solid products generated as a result of the reaction of the transformation of the selected organic matter at different times (t) and different temperatures (T). A compositional kinetic diagram is therefore constructed on the basis of the quantities obtained, from a full mass balance, for each t/T reaction pair. These measurements make it possible to characterize and quantify the products of reaction. In this way, the kinetic parameters of the Arrhenius equation: frequency factor Ai, activation energy Ei, relative contributions Xi of each of the individual reactions parallel to the total reaction, and composition (or stoichiometry) of the products of reaction for each of the individual reactions are determined. These relative proposals for each of the products, for each of the individual reactions, are usually denoted ni.

When the basin geologists do not have a sample on which to conduct laboratory analyses, it is commonplace for them to use existing kinetic parameters, for example those published in the literature such as in the document by Braun et al.,(1991). However, most of the kinetic parameters available to the public are non-compositional, or else have been established according to a number of classes of compounds which is not that desired by the operator.

The present invention seeks to convert any non-compositional kinetic diagram into a compositional kinetic diagram having a number of classes of compound chosen by the user, or else to convert any compositional kinetic diagram, characterized by a given number of classes of chemical compound, into a compositional kinetic diagram defined by a different number of classes of compound, chosen by the user, according to his needs.

The method according to the invention thus makes it possible to determine a compositional kinetic diagram that meets the operational needs, on the basis of existing proprietary or publicly-available, compositional or non-compositional primary-cracking kinetic parameters without the need to carry out lengthy and costly laboratory measurements.

### SUMMARY OF THE INVENTION

The present invention is a method implemented for a computer to determining at least one of the quantity and the quality of the hydrocarbons present in a sedimentary basin when the hydrocarbons have been generated by the maturation of the organic matter of a source rock of the basin, by use of a basin numerical simulator containing a kinetic model. The kinetic model is applied with kinetic parameters in order to reproduce the transformation of the organic matter into at least one chemical compound under the effect of an increase in temperature, on the basis of kinetic parameters relating to the source rock and relating to a first compositional representation.

The method according to the invention involves determining kinetic parameters relating to the source rock and relating to a second compositional representation by applying at least the following steps by use of the kinetic model:
A) from kinetic parameters relating to at least one reference source rock and relating to the second compositional representation, and from kinetic parameters relating to a reference rock and relating to the second compositional representation, a compositional reference for the second compositional representation is determined in the form of an evolution in a proportion of each of the chemical compounds of the second compositional representation as a function of a level of transformation of the reference rock;
B) from the kinetic parameters relating to the source rock and relating to the said first compositional representation, and from the compositional reference determined for the second compositional representation, kinetic parameters relating to the source rock and relating to the second compositional representation are determined; and
the method according to the invention then involves determining at least one of the quantity and the quality of the hydrocarbons from the simulator containing at least the kinetic model, the kinetic model being applied with the kinetic parameters relating to the source rock for the second compositional representation.

According to a first alternative form of the invention, the first compositional representation may contain a single class of chemical compounds resulting from the thermal maturation of the organic matter of the source rock.

According to a second alternative form of the invention, the first compositional representation may contain at least two classes of chemical compounds resulting from the thermal maturation of the organic matter of the source rock.

According to a first implementation of the invention, step A may comprise at least the following steps:
a) a first sequence of temperatures that allows a level of transformation of the said reference rock of 100% is defined, the first sequence of temperatures being a function of the temperature as a function of time;
b) from the kinetic model applied with the kinetic parameters of the reference rock and applied according to the first sequence of temperatures, the evolution of the level of transformation of the reference rock as a function of time is determined; from this a first law correlating the level of transformation of the reference rock and time for the first sequence of temperatures is deduced;
c) for each of the reference source rocks, from the kinetic model applied with the kinetic parameters relating to the reference source rock and applied according to the first sequence of temperatures, and from the first correlation law, (a curve representative of the evolution of the level of transformation of the reference source rock as a function of time and) the evolution of the proportion of each of the compounds of the classes of compounds for the reference source rock as a function of time are determined; and from this, for each of the compounds of the classes of compounds, an evolution of the proportion of each of the compounds is representative of each of the reference source rocks as a function of time is deduced.
d) for each of the compounds of the classes of compounds, the compositional reference for the second compositional representation is determined from the evolution of the proportion of each of the compounds representative of each of the reference source rocks as a function of time and from the first correlation law, the compositional reference comprising a reference proportion curve for each of the compounds of the second compositional representation as a function of the level of transformation of the reference rock.

According to one implementation of the invention, step B may comprise at least the following steps:
e) a second sequence of temperatures is defined, the second sequence of temperatures being a function of the temperature as a function of time;
f) from the kinetic model applied with the kinetic parameters relating to the reference rock and applied according to the second sequence of temperatures, the evolution of the level of transformation of the reference rock as a function of time is determined, and a second law correlating the level of transformation of the reference rock and time for the second sequence of temperatures is determined;
g) from the kinetic parameters relating to the source rock for the first compositional representation, a plurality of individual reactions is defined; for each of the individual reactions of the source rock, from the kinetic model applied with the kinetic parameters relating to the source rock of the basin and relating to the first compositional representation, the kinetic model being applied with the second sequence of temperatures, a curve representative of the evolution of the level of transformation of the source rock of the basin as a function of time for the individual reaction is determined; and from this, for each of the individual reactions, there is determined a curve representative of the evolution of the level of transformation of the source rock of the basin for the individual reaction as a function of the level of transformation of the reference rock using the second correlation law;
h) for each of the individual reactions and for each of the compounds of the classes of compounds of the second compositional representation, a proportion of the compound for the individual reaction is determined from the curve representative of the evolution of the reference proportion of the compound as a function of the level of transformation of the reference rock for the individual reaction and from a derivative of the curve representative of the evolution of the level of transformation of the source rock for the individual reaction as a function of the level of transformation of the reference rock;
i) the kinetic parameters relating to the source rock and relating to the second representation are determined from at least the proportions of the compounds of the classes of compounds of the second compositional representation for each of the individual reactions.

According to one implementation of the invention, from at least one of the quantity and the quality of the hydrocarbons of the basin, it is possible to define an exploitation diagram for the basin, and the sedimentary basin is exploited as a function of at least one of the quantification and the diagram.

The invention further relates to a computer program product that is downloadable from a communication network and/or recorded on a medium that is at least one of readable by computer and executable by a processor, comprising program code instructions for implementing the method such as described above, when the program is executed on a computer.

### BRIEF DESCRIPTION OF THE DRAWINGS

FIG. 1 shows examples of kinetic diagrams, each determined for a compositional representation comprising 4 classes of compounds C1, C2-C5, C6-C15, C15+, and for 5 different types of source rock.

FIG. 2 shows, by way of illustration, a kinetic diagram established for vitrinite by way of reference rock.

FIG. 3 schematically shows the principle of step 1 of the method according to the invention.

FIG. 4 shows, by way of illustration, a kinetic diagram established for a source rock of a basin in the case where the first compositional representation contains just one class of chemical compounds.

FIG. 5 shows an example of a curve representative of the evolution of the level of transformation of the source rock TR-SR for an individual reaction considered as a function of the level of transformation of the reference rock TR, together with the derivative of this curve.

FIG. 6 shows an example of a kinetic diagram established for a source rock of the Paris Basin in the case where the first compositional representation contains just one class of chemical compounds.

FIG. 7 shows a kinetic diagram resulting from the implementation of the method according to the invention for the source rock of FIG. 6 in the case where the second compositional representation comprises four classes of chemical compounds.

### DETAILED DESCRIPTION OF THE INVENTION

The present invention relates to a method for determining at least one of the quantity and the quality of the hydrocarbons present in a sedimentary basin with the hydrocarbons which have been generated by the maturation of the organic matter of a source rock of the basin.

The present invention requires a kinetic model that makes possible reproduction of the maturation of the organic matter of a source rock. The kinetic model according to the invention implements the conventional formula for the progress of a chemical reaction, which is of the type:

$$\begin{matrix}[ Math 1 ] & \\ \frac{dx}{dt} = - {kc}^{n} & ( 1 )\end{matrix}$$

where c represents the quantity of the chemical species considered, n represents the order of the reaction, k reaction rate constant, and t represents time.

In the conventional way, the reaction rate constant k is given by an empirical law, the Arrhenius law, which is expressed according to a formula of the type:

$$\begin{matrix}[ Math 2 ] & \\ k = A \cdot exp ( - \frac{E}{RT} ) & ( 2 )\end{matrix}$$

in which A is the frequency factor also referred to as the pre-exponential factor, E is the activation energy, R is the perfect-gas constant, and T is the temperature.

The complexity of the transformation of the solid kerogen into hydrocarbons is modelled by a set of parallel order-1 reactions. Each of these reactions can be represented by a kinetic law as defined by equations (1) and (2) above, and by a factor denoted Xi expressing its contribution relative to the overall reaction. Thus, each reaction is characterized by a distinct (Ai, Ei, Xi) triplet. The pair (Ai, Ei) defines a reaction rate, and the Xi defines the quantity of reactant likely to be used in this reaction, which can be expressed as a proportion of the hydrogen index, for example expressed in mg/gTOC or as a percentage of that same index, the sum of the Xi values being equal to the total quantity of reactant X. The set of triplets (Ai, Ei, Xi) and the proportion ni of each of the classes of compounds having an individual reaction of contribution Xi will be referred to hereinafter, and in the conventional way, as “kinetic parameters”.

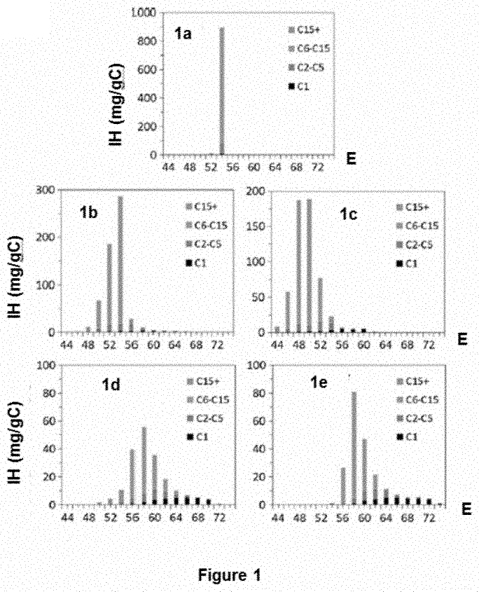

In the conventional way, the set of chemical compounds resulting from the transformation of the organic matter are grouped into classes of chemical compounds. Such an allocation into classes of compounds is referred to hereinafter as “compositional representation”. This compositional representation is also known by the name “kinetic diagram”. The set of compounds resulting from the transformation of the organic matter may for example be broken down into classes representative, for example, of C1, C2-C5, C6-C15, C15+ hydrocarbon compounds (namely as a compositional representation as 4 classes of compounds). FIG. 1 shows examples of compositional diagrams each determined for a compositional representation comprising 4 classes C1, C2-C5, C6-C15, C15+ of compounds, for 5 different types of source rock (where 1a:type I, 1b:type II, 1c:type II-S, 1d:type III, 1e:type III North Sea; and in which IH represents the hydrogen index). Each of the bars in these diagrams represents the total quantity (Xi) of compounds released for a given activation energy Ei, and each bar in a diagram is itself subdivided into sub elements representing the proportion (ni) of each of the classes of compounds released for this activation energy Ei.

Note that a compositional representation within the meaning of the invention may comprise only one single class of compounds. However, it should be noted that, in such a case, this type of representation is referred to in specialist jargon as being non-compositional.

Also, hereinafter, a level representative of the evolution of the transformation reaction of the organic matter at a given moment in time, is referred to as “level of transformation” and denoted TR. According to one implementation of the invention, this level of transformation can be defined by a formula of the type:

$$\begin{matrix}[ Math 3 ] & \\ TR = \frac{m}{m 0} & ( 3 )\end{matrix}$$

in which m is the mass of reactant at an instant t and m0 is the initial mass of reactant. A TR value equal to 0% expresses the fact that the preserved sedimentary organic matter (the kerogen) has not yet undergone transformation, something which occurs when the time and temperature conditions for significant reaction have not been met; the source rock is then said to be immature. Conversely, when all the kerogen of a source rock has been transformed, TR is equal to 100% and the reactions come to a halt through lack of reactant.

According to another implementation of the invention, the level of transformation may also be expressed as a function of the hydrogen index, denoted IH, in the same form:

$$\begin{matrix}[ Math 4 ] & \\ TR = \frac{IH}{IH 0} & ( 4 )\end{matrix}$$

in which IH is the hydrogen index of the reactant at an instant t and IH0 is the initial hydrogen index of the reactant. In general, the hydrogen index corresponds to the hydrogen content of the organic matter of the sample. According to one implementation of the invention, the hydrogen index can be obtained using a formula of the type:

$$\begin{matrix}[ Math 5 ] & \\ IH = \frac{S2 \cdot 100}{TOC} & ( 5 )\end{matrix}$$

in which S2 corresponds to a quantity of hydrocarbon compounds which have been cracked during the heating of the sample (which therefore does not contain the hydrocarbon compounds present in free form in the source rock) in an inert atmosphere, and TOC corresponds to the total organic carbon content. Thus, for the one same source rock, the parameters IH and S2 decrease as a function of the thermal maturity of the organic matter and this maturity is determined by the temperature at which the spike S2 reaches a maximum (Tₘₐₓ). According to one implementation of the invention, this hydrogen index can be determined from at least the quantity of hydrocarbon compounds and of CO and CO₂ measured during a sequence of heating in an inert atmosphere and from the quantities of CO and of CO₂ measured during a sequence of heating in an oxidising atmosphere, these measurements being carried out for example using the ROCK-EVAL® device (IFP Energies nouvelles, France).

In general, the method according to the invention seeks to determine, for a source rock of a sedimentary basin, the kinetic parameters relating to one given compositional representation, from kinetic parameters relating to another compositional representation, without the need to carry out additional measurements. Hereinafter, the compositional representation for which kinetic parameters are already available is referred to as “first compositional representation” and the compositional representation for which the invention seeks to determine the kinetic parameters is referred to as “second compositional representation”. According to one implementation of the invention, the first compositional representation may comprise a single class of chemical compounds.

The present invention relies chiefly on two aspects:

the establishing of a compositional reference (cf. step 1 below) for the second compositional representation, determined from kinetic parameters established for at least one source rock, but preferably for a plurality of source rocks referred to as “reference source rocks”, and for the second compositional representation. The compositional reference according to the invention may be seen as an “average” distribution of the chemical compounds released during the transformation of the organic matter in general, which is established from the set of reference source rocks considered and for the second compositional representation. Thus, the compositional reference according to the invention is determined from the results of compositional laboratory measurements for at least one source rock, and preferably for a plurality of source rocks, preferably representative of the variety of source rocks present in sedimentary basins (particularly representative of source rocks of types I, II, IIS and III). The present invention can be implemented on the basis of kinetic parameters relating to a single reference source rock, but the higher the number of reference source rocks considered, the more reliable the compositional reference will be. In addition, it is particularly advantageous for the reference source rocks to cover a broad energy spectrum.

For preference, the number of reference source rocks is 4 (for the four main types of organic matter) and, highly preferably, the number of reference source rocks is 10. The compositional reference is furthermore expressed as a function of a reference kinetic as described below.

the use of a reference kinetic, established for a reference rock such as vitrinite, in order to get around the infinite number of combinations of (temperature, time) pairs that yield the same reaction progress. Specifically, for a given quantity of product, the composition generated is dependent on the energy received by the system. This energy is directly indicated by the progress of the reaction (which is obtained by combining the Arrhenius law and the reaction rate law) and is a function of temperature T and time t. There are thus an infinite number of (T, t) pairs that yield the same reaction progress. That means that a high temperature and a short time may, in terms of reaction progress, be equivalent to a low temperature over a very long period.

The method according to the invention comprises at least the following steps:

### 1) Determining a Compositional Reference for the Second Compositional Representation

2) Converting the Kinetic Parameters of a First Compositional Representation into Kinetic Parameters of a Second Compositional Representation
3) Determining the quantity and/or the quality of the hydrocarbons
4) Exploitating the hydrocarbons of the formation

The steps of the method according to the invention are described below in the case of a plurality of reference source rocks, but may just as well be applied for just one single reference source rock.

### 1) Determining a Compositional Reference for the Second Compositional Representation

During this step, a compositional reference for the second compositional representation is determined in the form of an evolution in the proportion of each of the chemical compounds of the second compositional representation as a function of a level of transformation of a reference rock.

This step is carried out on the basis of:

kinetic parameters relating to an at least one reference source rock, these parameters having been determined for the second compositional representation beforehand. Highly preferably, the method according to the invention is implemented on the basis of the kinetic parameters of a plurality of source rocks, preferably at least 4 source rocks, and highly preferably, 10 source rocks. Furthermore, highly preferably, these source rocks come from different types of source rock (for example, according to the conventional classification as type I, type II, type II-S, type III), or else according to the organofacies classification described in the Pepper et Corvi document (1995).

kinetic parameters relating to a reference rock, these parameters having been determined beforehand by non-compositional analysis. These parameters may have been determined during a prior step of the method according to the invention, or else may originate from any database well known to the specialist. According to the invention, the reference rock is a rock for which the chemical transformation takes place according to time and temperature scales that are of the same order of magnitude as those that characterize the transformation of organic matter in sedimentary basins (namely, by way of example, in a range of temperatures between 80° C. and 130° C. and a time range between 10 and 100 Ma, where “Ma” corresponds to “millions of years”).

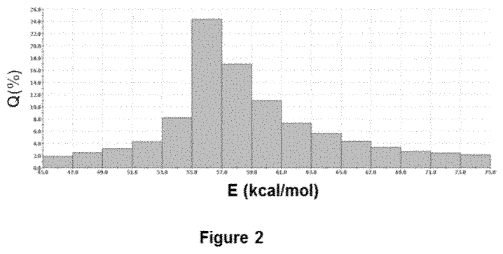

According to one implementation of the invention, the reference rock may be vitrinite. Vitrinite offers the advantage that the kinetic law associated with it is well known and is, furthermore, most often measured during exploratory campaigns exploring sedimentary basins. One example of a kinetic diagram associated with vitrinite by way of reference rock is given in FIG. 2. This diagram shows the quantity Q (in %) of compounds released as a function of activation energy E.

According to one implementation of the invention, step 1) is applied as the following sub-steps:

### 1.1 Defining a First Sequence of Temperatures

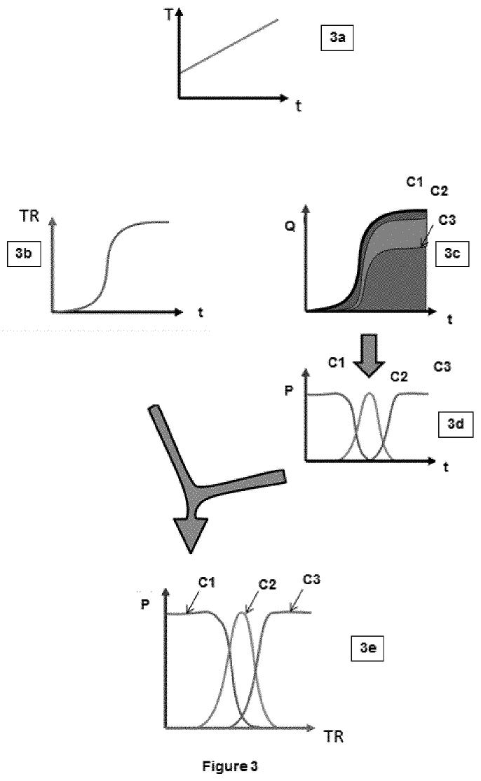

According to this implementation of the invention, a first sequence of temperatures, such as a function of temperature as a function of time is defined . The curve referenced “3a” in FIG. 3 schematically illustrates such a sequence of temperature T as a function of time t.

According to one implementation of the invention, this first sequence is a sequence conventionally defined in the case of experiments conducted in the laboratory such as, for example, using the ROCK-EVAL® device (IFP Energies nouvelles, France).

According to the invention, it is important for the sequence chosen to allow 100% transformation of the reference rock. The person skilled in the art is perfectly aware of means for defining such a sequence that ensures 100% transformation of the reference rock. Particularly in the case of a time sequence on a laboratory scale, it is enough to lengthen the conventional measurement duration (for example by one hour) and/or to increase the final temperature of the sequence (for example by 100° C.). According to one implementation of the invention whereby the reference rock is vitrinite, the following temperature sequence may be used: the starting temperature T1=200° C. and the temperature is increased to a temperature T2=800° C. as a gradient of 5° C./min.

The temperature sequence thus defined is then used for all of the sub steps of step 1 of establishing a compositional reference.

### 1.2 Determining a First Correlation Law

During this sub-step, a first law expressing the correlation between the level of transformation of the reference rock and the time for the first sequence of temperatures is determined.

According to one implementation of the invention, the kinetic model according to the invention is applied with the kinetic parameters of the chosen reference rock and according to the first sequence of temperatures. In this way, a curve representative of the evolution of the level of transformation of the reference rock as a function of time is determined. The curve referenced “3b” in FIG. 3 schematically illustrates a curve representative of the evolution of the level of transformation TR of the reference rock as a function of time t.

A first law expressing the correlation between the level of transformation of the reference rock and the time for the said first sequence of temperatures is then determined This deduction is immediate because it is the inverse function of the curve representative of the evolution of the level of transformation of the reference rock as a function of time.

### 1.3 Determining an Evolution in the Proportion of Each of the Compounds for the Reference Source Rocks

During this sub-step, for each of the compounds of the classes of compounds of the second compositional representation, there is determined a curve representative of the evolution of the proportion of this compound as a function of time, this curve being representative of all of the reference source rocks.

According to one implementation of the invention, there is determined, first of all, for each reference source rock, an evolution of the quantity of each of the compounds of the second compositional representation, as a function of time, by use of the kinetic model applied with the kinetic parameters relating to the reference source rock being considered, the kinetic model being applied according to the first sequence of temperatures. The diagram referenced “3c” in FIG. 3 shows, purely by way of illustration, the evolution of the simulated composition Q as a function of time t the three classes of compounds c1, c2, c3.

Next, from this simulation of the evolution of the quantities of each of the compounds released for a given source rock, an evolution of the proportion of each of these compounds as a function of time is determined, and this is done for each of the reference source rocks. Diagram “3d” in FIG. 3 shows, purely by way of illustration, the evolution of the proportion P of the three classes of compounds c1, c2, c3 as a function of time. These curves may be viewed as normalized instantaneous compositions.

Then, from the set of curves of proportions of compounds determined for all of the reference source rocks, a proportions curve representative of all of these proportions curves determined for all of the reference source rocks is determined, and this is done for each compound.

In order to do this, according to one implementation of the invention, each compound of the second compositional representation, the proportions of this compound which have been obtained for each of the reference source rocks are averaged to produce a mean, and this is done for each instant t. Alternatively, a mode is used in place of a mean, that is it is the most frequently occurring value that is adopted.

Hereinafter, but solely for the purposes of simplifying the explanation, reference will be made to curves of “average” proportions, in the sense that these curves are representative of a set of curves relating to a set of reference source rocks.

### 1.4 Determining a Compositional Reference for the Second Compositional Representation

During this sub-step, a compositional reference for the second compositional representation is determined.

According to one implementation of the invention, a curve representative of the evolution of the proportion of each of the compounds as a function of the level of transformation of the reference rock is determined from the curves representative of the evolution of the proportion of each of the compounds as a function of time for the plurality of reference source rocks and from the first correlation law. The curve referenced “3e” in FIG. 3 schematically illustrates the evolution of the proportion P of the three classes of compound c1, c2, c3 as a function of the level of transformation TR of the reference rock.

A knowledgeable person knows how to implement such a step because it involves a simple change of variable in so for as the curves of proportions of compounds expressed in terms of time are simply converted into curves of proportions of compounds expressed in terms of level of transformation, using the first correlation law, established in sub-step 1.2 described above, that gives the correlation between time and level of transformation.

This step makes it possible to obtain “averaged” curves of the evolution of proportions of chemical compounds released by the organic matter for a wide variety of source rocks. These curves are expressed on a scale that is invariable, relative to a reference rock as far as those with knowledge are concerned.

This set of proportions curves established by taking account for the set of proportions curves obtained for each of the reference source rocks is referred to hereinafter as a “compositional reference”.

2) Converting the Kinetic Parameters of a First Compositional Representation into Kinetic Parameters of a Second Compositional Representation

The second step seeks to convert kinetic parameters relating to the source rock under study, which has been established according to a first compositional representation, into kinetic parameters relating to a second compositional representation, and to do so on the basis of the compositional reference determined for the second compositional reference as described in step 1.

Thus, it may be a matter of converting existing kinetic parameters, which have been determined beforehand for a given compositional representation (referred to as “first compositional representation”), into kinetic parameters according to a new compositional representation (referred to as “second compositional representation”) that meets the current operational needs. FIG. 4 shows, by way of illustration, a kinetic diagram established for a source rock of a basin in the case where the first compositional representation contains just one class of chemical compounds. Each bar of this bar chart represents the total quantity Q of compounds released for a given activation energy E, but does not give the proportions of each of these compounds for this activation energy.

According to one implementation of the invention, step 2) is applied as the following sub-steps:

### 2.1 Defining a Second Sequence of Temperatures

According to this implementation of the invention, a second sequence of temperatures, such as a function of temperature as a function of time is defined.

In general, the method according to the invention does not require the sequences of temperatures of step 1 and 2 to differ from one another. In general, the two temperature sequences are distinguished from one another because the first step can be implemented entirely independently of the second step. However, according to one implementation of the invention, the second sequence of temperatures may be identical to the first sequence of temperatures defined for the implementation of step 1.

According to one implementation of the invention, this second sequence is a sequence conventionally defined in the case of experiments conducted in the laboratory such as, for example, using the ROCK-EVAL® device (IFP Energies nouvelles, France).

According to this implementation of the invention, it is important for the sequence chosen to allow 100% transformation of the reference rock. The person skilled in the art is perfectly aware of means for defining such a sequence that ensures 100% transformation of the reference rock. Particularly in the case of a time sequence on a laboratory scale, it is enough to at least one of lengthen the conventional measurement duration (for example by one hour) and to increase the final temperature of the sequence (for example by 100° C.). According to one implementation of the invention whereby the reference rock is vitrinite, the following temperature sequence may be used: the starting temperature T1=200° C. and the temperature is increased to a temperature T2=800° C. as a gradient of 5° C./min.

The temperature sequence thus defined is then used for all of the sub-steps of step 2 of establishing a compositional reference.

### 2.2 Determining a Second Correlation Law

During this sub-step, a second law expressing the correlation between the level of transformation of the reference rock and the time for the second sequence of temperatures is determined. When the second sequence of temperatures is identical to the first sequence of temperatures, this step becomes optional. Specifically, in that case, the first correlation law can be used as the second correlation law to implement step 2.

According to one implementation of the invention, wherein the second sequence of temperatures is distinct from the first sequence of temperatures, the kinetic model according to the invention is applied with the kinetic parameters of the chosen reference rock, according to the second sequence of temperatures. In this way, a curve representative of the evolution of the level of transformation of the reference rock as a function of time for the second sequence of temperatures is determined.

A second law expressing the correlation between the level of transformation of the reference rock and the time for the second sequence of temperatures is then determined. This deduction is immediate because it is the inverse function of the curve representative of the evolution of the level of transformation of the reference rock as a function of time.

### 2.3 Determining the Evolution of the Level of Transformation of the Source Rock for Each Individual Reaction as a Function of the Level of Transformation of the Reference Rock

This sub-step is implemented on the basis of the kinetic parameters relating to the source rock under study and which have been established for a first compositional representation.

From these kinetic parameters, a set of individual reactions is defined. According to one implementation of the invention, an individual reaction may correspond to a given (Ai, Ei) pair (cf. equations (1) and (2) above).

Next, for each individual reaction, using the kinetic model applied with the kinetic parameters relating to this individual reaction and applied according to the second sequence of temperatures, an evolution in its level of transformation of the source rock of the basin as a function of time is determined.

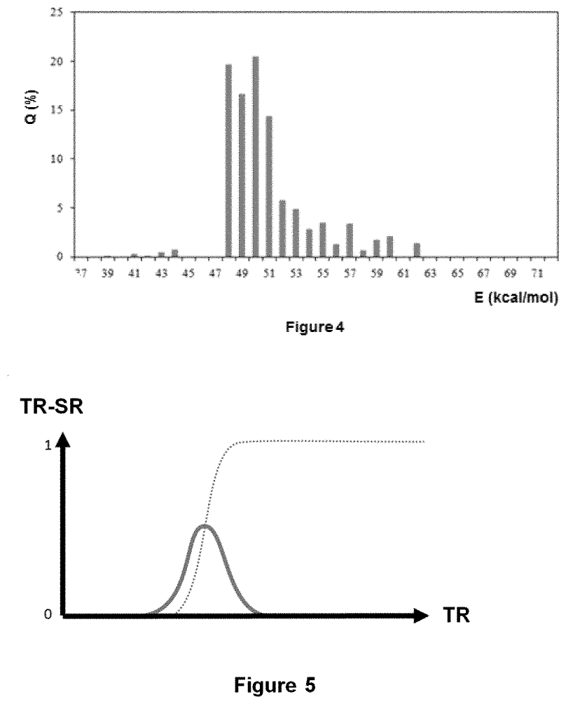

Then, for each individual reaction, and from the second correlation law determined in sub-step 2.2, a curve representative of the evolution of the level of transformation of the source rock for the individual reaction considered as a function of the level of transformation of the reference rock is determined. In other words, in simpler terms, a change in variable is being performed here since, instead of the level of transformation being expressed as a function of time, it is now expressed as a function of a level of transformation of a reference rock, by using the second correlation law. One example of such a curve is the curve shown in dotted lines in FIG. 5. This curve represents the progress TR-SR of the (individual) reaction as a function of the progress of the reference kinetic TR, namely the cumulative mass produced.

Then, for each individual reaction, a derivative of this curve representative of the evolution of the level of transformation of the source rock for the individual reaction considered as a function of the level of transformation of the reference rock is determined. One example of such a curve is the curve shown in solid line in FIG. 5. This curve represents the distribution of the masses produced as a function of the progress of the reference kinetic.

2.4 Determining the Proportion of Compounds per Individual Reaction and Determining the Kinetic Parameters for the Second Compositional Representation using the Curve Shown in Solid Line

This sub-step is applied for each of the individual reactions defined in the previous sub-step, and for each of the compounds of the classes of compounds of the second compositional representation.

More specifically, for each of the individual reactions and for each of the compounds of the classes of compounds of the second compositional representation, a proportion of the compound considered for the individual reaction considered is determined from the compositional reference determined at the outcome of step 1 for the second compositional representation and from the derivative of the curve representative of the evolution of the level of transformation of the source rock determined in the previous sub-step for the individual reaction considered.

According to one implementation of the invention, this sub-step is implemented by calculating an integral of the proportion curve determined at the outcome of step 1 for the compound considered, weighted by the derivative determined in the previous sub-step, integration being performed on the level of transformation of the reference rock. In this way, the mass of the compound considered, for the reaction considered, is obtained.

By repeating this operation for all of the individual reactions (namely for various values or intervals for the activation energy Ei), and for each compound or each class of compounds of the second compositional representation, the full set of kinetic parameters relating to the second compositional representation is thus obtained.

3) Determining the Quantity and/or the Quality of the Hydrocarbons

At the end of the previous step there is obtained a set of kinetic parameters relating to the source rock of the basin under study, for the second compositional representation which is the compositional representation of interest in evaluating the oil and/or gas potential of the basin under study. It is then possible to use a kinetic model, fed with these kinetic parameters, to evaluate at least one of the oil and gas potential of the basin under study.

More specifically, during the course of this step, at least one of the quantity and the quality of the hydrocarbons present in the sedimentary basin under study is determined from kinetic parameters determined at the outcome of the previous step and from the kinetic model as described by equations (1) and (2) above, with these kinetic parameters.

According to the invention, the kinetic model according to the invention is incorporated into a numerical basin simulation executed on a computer. In the conventional way, a basin simulator makes it possible to reconstruct at least one of geological and geochemical processes that have affected the basin over a geological time t up to the present day. In the conventional way, the period over which the history of this basin is reconstructed is discretized into geological events also known as states. Thus, two states are separated by a geological event (corresponding for example to a particular sedimentary deposit and which may be spread over a period of between about a hundred years and several million years). A basin simulator relies on a meshed representation of the basin, also referred to as “basin model”, and the basin simulator makes it possible to determine such a model for each state. Thus, a basin simulator makes it possible to compute physical values relating to the basin under study at each mesh of the measured representation associated with each state. The physical values estimated by a basin simulator generally include the temperature, the pressure, the porosity and the density of the rock contained in the mesh cell being considered, the water speed and the TOC (or organic-matter concentration of the rock). In the conventional way, a basin simulator also makes it possible to compute the quantity and composition of hydrocarbons of thermogenic origin, using a kinetic model fed with kinetic parameters. Thus, basin simulation resolves a system of differential equations that describe the evolution over time of the physical values under study. In order to do this, use may be made, for example, of a finite-volume method of discretization, as described for example in Scheichl et al., (2003). For each state, it is necessary to resolve the equations in small increments of time (that is with a small step dt of time) to the next state. According to the principle of mesh-centred finite-volume methods, the unknowns are discretized by a constant value per mesh cell and the conservation (of mass or heat) equations are integrated with respect to space on each mesh cell and with respect to time between two successive time steps. The discrete equations then express the fact that the quantity conserved in a mesh cell at a given time step is equal to the quantity contained in the mesh cell at the previous time step, increased by the flows of quantities that have entered the mesh cell, and reduced by the flows of quantities that have left the mesh cell via its faces, plus external additions. One example of such a basin simulator is the TemisFlow™ software (IFP Energies nouvelles, France).

According to the invention, the basin simulator comprises a kinetic model as described hereinabove, and this kinetic model is applied by using the kinetic parameters as determined at the outcome of step 2 for the compositional representation of interest to the basin geologist. That makes it possible to obtain, for each mesh cell of the meshed representation of the sedimentary basin, an estimate of the quantity of hydrocarbons produced by the transformation of the organic matter present in the basin over the course of time, and also, because of the fact that the kinetic parameters used relate to a compositional representation, an estimate of the composition of the hydrocarbons produced over the course of time, for each of the mesh cells of the basin model. The composition of the hydrocarbons produced provides a knowledgeable person with information as to the quality of the hydrocarbons. Indeed it is quite obvious that the lightest hydrocarbons are considered to be better quality hydrocarbons than heavy and very-heavy hydrocarbons. Such information regarding the quantity and quality of the hydrocarbons thus makes it possible to evaluate at least one of the oil and gas potential of a sedimentary basin.

Thus, the present invention makes it possible to convert existing, non-compositional or compositional, kinetics into compositional kinetics having a number of classes of compounds chosen by the user according to his needs, and thus to predict at least one of the oil and gas potential of the basin without having to carry out lengthy and costly laboratory experiments.

### 4) Exploiting the Hydrocarbons of the Basin

At the outcome of the previous steps, at least one of the quantity and the quality of the hydrocarbons present in each of the mesh cells of the basin model at the current time is available.

Furthermore, depending on the basin simulator used to implement the invention, information may be available regarding:

i. the laying-down of the sedimentary layers,

ii. their compaction under the effect of the weight of the sediment on top of them,

iii. their heating as they have gradually become buried,

iv. changes in fluid pressures as a result of this burial,

v. the formation of the hydrocarbons formed by thermogenesis, and

vi. the movement of these hydrocarbons through the basin under the effect of buoyancy, capillarity, differences in pressure gradients, underground flow.

On the basis of such information, the knowledgeable person is aware of the regions of the basin, corresponding to cells of the meshed representation of the basin at the current time, that contain hydrocarbons, and of the content, the nature and the pressure of the hydrocarbons that are trapped therein. Those skilled in the art will then be able to select the zones of the basin under study that present the best of at least one of oil and gas potential.

The development of the basin for at least oil and gas exploitation may then take a number of forms, in particular:
exploration wells may be drilled into the various zones selected as having the best potential, in order to confirm or disprove the potential estimated beforehand, and to acquire new data to feed to new, more precise studies,
development wells (production or injection wells) may be drilled in order to recover hydrocarbons present within the sedimentary basin in the zones selected as having the best potential.

### Equipment and Computer Program Product

The method according to the invention is implemented by use of processing equipment (for example a computer workstation) comprising data processing capability (a processor) and data storage (a memory, in particular a hard disk), and an input/output interface for inputting data and returning the results of the method.

The data processing capability is configured notably to carry out step 3 above, in which step at least one of the quantity and the quality of the hydrocarbons is determined from a numerical basin simulator comprising at least one kinetic model applied with the kinetic parameters determined at the outcome of step 2.

In addition, the invention relates to a computer program product which is downloadable from at least one of the communication network and recorded on a medium which is readable by computer and/or executable by a processor, comprising program code instructions for the implementation of the method as described above, when the program is executed on a computer.

### EXAMPLES

The features and advantages of the method according to the invention will become more clearly apparent on reading about the following example of application.

The method according to the invention is applied to the Paris Basin (France). This basin is a sedimentary basin covering 140 000 km², measuring 500 km from east to west, by 300 km from north to south, formed of concentric sedimentary layers typical of intracratonic basins.

One of the chief source rocks giving rise to the hydrocarbons in place is from the toaracian age. It contains a type II (marine) kerogen with a total initial hydrogen index (IHO) of the order of 600 mgHC/gR.

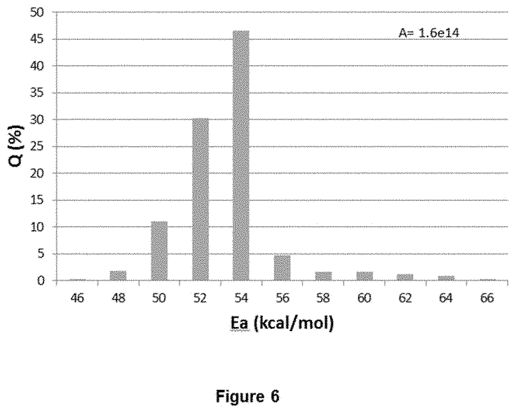

The method according to the invention is implemented on the basis of kinetic parameters relating to a first compositional representation defined by a single class of chemical compounds. FIG. 6 shows a compositional diagram relating to this first compositional representation, representing the quantity Q (in %) of compounds released as a function of the activation energy E.

The method according to the invention is implemented in order to determine the kinetic parameters relating to a new compositional representation adapted to suit the operational requirements, defined by 4 “mobile” classes of compounds: 1 “gas” chemical fraction (denoted G) (compounds in the vapor state under surface conditions), and 3 “oil” chemical fractions of variable densities (H =heavy oil 940 kg/m³, M=oil of intermediate density 860 kg/m³, L=light oil−condensate 780 kg/m³).

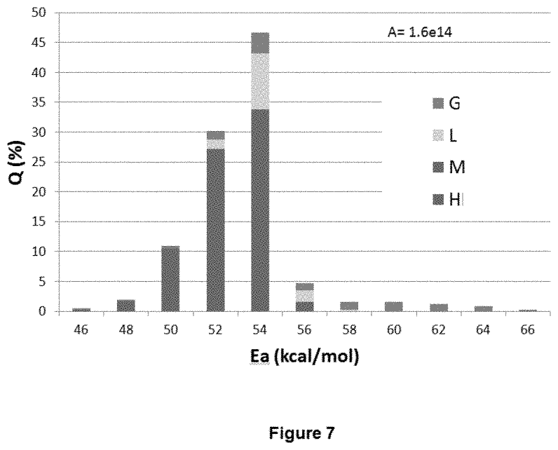

FIG. 7 shows the compositional diagram obtained by use of the kinetic parameters relating to the second compositional representation as determined at the outcome of the method according to the invention. Thus is obtained the quantity Q (in %) of each of the released compounds of the second compositional representation as a function of the activation energy.

Thus, the method according to the invention makes it possible, without the need to conduct lengthy and costly laboratory measurements, to convert any existing kinetic diagram into a compositional kinetic diagram having a number of classes of chemical compounds chosen by the skilled person according to that person's operational needs.

1.-7. (canceled)

8. A computer implemented method for determining at least one of quantity and quality of the hydrocarbons present in a sedimentary basin, the hydrocarbons having been generated by maturation of organic matter of a source rock of the basin, by using a numerical basin simulator containing a kinetic model, the kinetic model being supplied with kinetic parameters to reproduce transformation of the organic matter into at least one chemical compound under an effect of an increase in temperature, based on one of kinetic parameters relating the source rock and relating to a first compositional representation,
characterized by kinetic parameters relating to the source rock and relating to a second compositional representation determined by steps by use of the kinetic model, the first and second compositional representations being defined by a different number of classes of chemical compounds comprising:
A) determining a compositional reference for the second compositional representation for the second compositional reference from kinetic parameters relating to at least one reference source rock and relating to the second compositional representation, and from kinetic parameters relating to a reference rock and relating to the second compositional representation, in a form of evolution in proportion to each chemical compounds of the second compositional representation as a function of a level of transformation of the reference rock;
B) determining kinetic parameters relating to the source rock and relating to the second compositional representation from the kinetic parameters relating to the source rock and relating to the first compositional representation, and from the compositional reference determined for the second compositional representation; and
determining at least one of the quantity and the quality of the hydrocarbons from the simulator containing at least the kinetic model being supplied with the kinetic parameters relating to the source rock for the second compositional representation.

9. The method according to claim 8, wherein the first compositional representation contains a single class of chemical compounds resulting from thermal maturation of the organic matter of the source rock.

10. Method according to claim 8, wherein the first compositional representation contains at least two classes of chemical compounds resulting from the thermal maturation of the organic matter of the source rock.

11. The method according to claim 8, in which step A comprises at least the following steps:
a) defining a first sequence of temperatures that allow a level of transformation of the reference rock of 100% and the first sequence of temperatures being a function of the temperature as a function of time;
b) determining the evolution of a level of transformation of the reference rock as a function of time from the kinetic model applied with the kinetic parameters of the reference rock and applied according to the first sequence of temperatures and correlating the determined information from a first law correlating the level of transformation of the reference rock and determining time for the first sequence of temperatures;
c) for each of the reference source rocks, from the kinetic model supplied with the kinetic parameters relating to the reference source rock and supplied according to the first sequence of temperatures, and from the first correlation law, which is a curve representative of the evolution of the level of transformation of the reference source rock as a function of time;
determining the evolution of a proportion of each of the compounds of the classes of compounds of the second compositional representation for the reference source rock as a function of time; and for each of the compounds of the classes of compounds of the second compositional representation, determining an evolution of the proportion of each of the compounds of the second compositional representation representative of each of the reference source rocks as a function of time;
d) for each of the compounds of the classes of compounds of the second compositional representation, determining the compositional reference for the second compositional representation from the evolution of the proportion of each of the compounds representative of each of the reference source rocks as a function of time and from the first correlation law, and the compositional reference comprising a reference proportion curve for each of the compounds of the second compositional representation being a function of the level of transformation of the reference rock.

12. The method according to claim 9, in which step A comprises at least the following steps:
a) defining a first sequence of temperatures allowing a level of transformation of the reference rock of 100%, the first sequence of temperatures being a function of the temperature as a function of time;
b) determining the evolution of a level of transformation of the reference rock as a function of time from the kinetic model supplied with the kinetic parameters of the reference rock and supplied according to the first sequence of temperatures and correlating the determined information a first law correlating the level of transformation of the reference rock and determining time for the first sequence of temperatures;
c) for each of the reference source rocks, from the kinetic model applied with the kinetic parameters relating to the reference source rock and supplied according to the first sequence of temperatures, and from the first correlation law which is a curve representative of the evolution of the level of transformation of the reference source rock as a function of time and determining the evolution of proportion of each of the compounds of the classes of compounds of the second compositional representation for the reference source rock as a function of time; and determining for each of the compounds of the classes of compounds of the second compositional representation, an evolution of the proportion of each of the compounds of the second compositional representation representative of each of the reference source rocks as a function of time; and
d) determining for each of the compounds of the classes of compounds of the second compositional representation, the compositional reference for the second compositional representation which is determined from the evolution of the proportion of each of the compounds representative of each of the reference source rocks as a function of time and from the first correlation law, and the compositional reference comprising a reference proportion curve for each of the compounds of the second compositional representation as a function of the level of transformation of the reference rock.

13. The method according to claim 10, in which step A comprises at least the following steps:
a) defining a first sequence of temperatures allowing a level of transformation of the reference rock of 100%, the first sequence of temperatures being a function of the temperature as a function of time;
b) determining the evolution of a level of transformation of the reference rock as a function of time from the kinetic model applied with the kinetic parameters of the reference rock and supplied according to the first sequence of temperatures and correlating the determined information a first law correlating the level of transformation of the reference rock and determining time for the first sequence of temperatures;
c) for each of the reference source rocks, from the kinetic model applied with the kinetic parameters relating to the reference source rock and supplied according to the first sequence of temperatures, and from the first correlation law, which is a curve representative of the evolution of the level of transformation of the reference source rock as a function of time;
determining the evolution of proportion of each of the compounds of the classes of compounds of the second compositional representation for the reference source rock as a function of time and determining for each of the compounds of the classes of compounds of the second compositional representation, an evolution of the proportion of each of the compounds of the second compositional representation representative of each of the reference source rocks as a function of time;
d) for each of the compounds of the classes of compounds of the second compositional representation, the compositional reference for the second compositional representation is determined from the evolution of the proportion of each of the compounds representative of each of the reference source rocks as a function of time and from the first correlation law, and the compositional reference comprising a reference proportion curve for each of the compounds of the second compositional representation as a function of the level of transformation of the reference rock.

14. The method according to claim 11, in which step A comprises at least the following steps:
a) defining a first sequence of temperatures that allow a level of transformation of the reference rock of 100%, the first sequence of temperatures being a function of the temperature as a function of time;
b) determining the evolution of a level of transformation of the reference rock as a function of time from the kinetic model applied with the kinetic parameters of the reference rock and applied according to the first sequence of temperatures; correlating the determined information a first law correlating the level of transformation of the reference rock and determining time for the first sequence of temperatures;
c) for each of the reference source rocks, from the kinetic model applied with the kinetic parameters relating to the reference source rock and applied according to the first sequence of temperatures, and from the first correlation law, which is a curve representative of the evolution of the level of transformation of the said reference source rock as a function of time;
determining the evolution of proportion of each of the compounds of the classes of compounds of the second compositional representation for the reference source rock as a function of time; and determining for each of the compounds of the classes of compounds of the second compositional representation, an evolution of the proportion of each of the compounds of the second compositional representation representative of each of the reference source rocks as a function of time; and
d) determining for each of the compounds of the classes of compounds of the second compositional representation, the compositional reference for the second compositional representation is determined from the evolution of the proportion of each of the compounds representative of each of the reference source rocks as a function of time and from the first correlation law, and the compositional reference comprises a reference proportion curve for each of the compounds of the second compositional representation as a function of the level of transformation of the reference rock.

15. The method according to claim 11, in which the step B comprises:
i) defining a second sequence of temperatures which is a function of the temperature as a function of time;
ii) determining the evolution of a level of transformation of the reference rock as a function of time, from the kinetic model applied with the kinetic parameters relating to the reference rock supplied according to the second sequence of temperatures and determining a second law correlating a level of transformation of the reference rock and time for the second sequence of temperatures;
iii) defining a plurality of individual reactions from the kinetic parameters relating to the source rock for the first compositional representation for each of the individual reactions of the source rock, from the kinetic model applied with the kinetic parameters relating to the source rock of the basin and relating to the first compositional representation, supplying the kinetic model with the second sequence of temperatures, determining a curve representative of the evolution of the level of transformation of the source rock of the basin as a function of time for the individual reaction; determining for each of the individual reactions, a curve representative of the evolution of the level of transformation of the source rock of the basin for the individual reaction as a function of the level of transformation of the reference rock using the second correlation law;
iv) determining for each of the individual reactions and for each of the compounds of the classes of compounds of the second compositional representation, a proportion of the compound for the individual reaction from the curve representative of the evolution of the reference proportion of the compound as a function of the level of transformation of the reference rock for the individual reaction and from a derivative of the curve representative of the evolution of a level of transformation of the source rock for the individual reaction as a function of the level of transformation of the reference rock; and
determining the kinetic parameters relating to the source rock and relating to the second representation from at least the proportions of the compounds of the classes of compounds of the second compositional representation for each of the individual reactions.

16. The method according to claim 8, comprising defining an exploitation diagram the basin from at least one of the quantity and the quality of the hydrocarbons of the basin and exploiting the sedimentary basin as a function of at least one of the quantification and qualification of the diagram.

17. A computer program product which is executable by a programmed processor, comprising program code instructions for implementing the method according to claim 8, comprising executing the program on the programmed processor.
